(19) United States
(12) Patent Application Publication
(10) Pub. No.: US 2024/0212914 A1
(43) Pub. Date: Jun. 27, 2024

(54) Low Power Loss High-Frequency 3D Planar Coils

(71) Applicants: Hengchun Mao, Allen, TX (US); Xuezhong Jia, Allen, TX (US)

(72) Inventors: Hengchun Mao, Allen, TX (US); Xuezhong Jia, Allen, TX (US)

(21) Appl. No.: 18/089,438

(22) Filed: Dec. 27, 2022

(51) Int. Cl. H01F 27/28; H01F 27/10; H01F 27/29; H01F 27/32; H02J 50/10

(52) U.S. Cl. CPC H01F 27/2804; H01F 27/10; H01F 27/29; H01F 27/323; H02J 50/10; H01F 2027/2809

(57) ABSTRACT

A coil with a plurality of conductors has a width much bigger than a thickness in a 3D structure. The plurality of conductors forms a conductive structure having a top conductive portion formed on a first planar surface, a first edge conductive portion formed along a first sidewall, a bottom conductive portion formed on a second planar surface and a second edge conductive portion formed on a second sidewall. The top conductive portion and the first edge conductive portion form a first L-shaped structure, the bottom conductive portion and the second edge conductive portion form a second L-shaped structure, and the first L-shaped structure and the second L-shaped structure are configured to form a low ac resistance structure. The coil also has an insulation material inside the conductive structure and a plurality of terminals formed with the plurality of conductors for connecting the coil.

### CROSS REFERENCE TO RELATED APPLICATIONS

This application claims priority to U.S. Provisional Application No. 63/294,285, filed on Dec. 28, 2021, entitled “Low Power Loss Tabular Coils”, which is herein incorporated by reference.

### TECHNICAL FIELD

The present invention relates to innovative planar coil technologies for high-frequency power processing, such as power conversion and power electronics devices and systems, and, in particular embodiments, to wireless power transfer systems and devices.

### BACKGROUND

Efficient coils and conductors are important for many power processing applications, such as RF power, power conversion, and wireless power transfer (WPT). It is always desirable to reduce the resistance and thus power loss of conductors and coils. This becomes a very difficult task at high frequency, as the skin effect and proximity effect become stronger at higher frequencies. Shallow conductors such as a tube have been used to reduce ac resistance (and thus power losses at high frequencies) in the past. The cross section of such shallow conductors is usually round or square, or rectangular with height and width relatively close. This kind of structure is not effective when frequency becomes very high. For example, at a frequency of 6.78 MHz, the skin depth of copper is about 20 um, so it is very difficult to build a round shape tubular conductor with a reasonable size to conduct a high current. Also, the manufacturing of such shallow conductors has a high cost because they are not compatible with mass production process such as printed circuit board (PCB) fabrication. This disclosure will present several innovative ideas to improve traditional shallow conductors using cost-effective planar construction for high frequency applications.

### SUMMARY OF THE INVENTION

These and other problems are generally solved or circumvented, and technical advantages are generally achieved, by preferred embodiments of the present invention which provides an improved conductor and coil structure suitable for high-frequency high-current power applications based on planar constructions.

According to one embodiment of this disclosure, a coil with a plurality of conductors and has a width much bigger than a thickness in a 3D structure. The plurality of conductors forms a conductive structure having a top conductive portion formed on a first planar surface, a first edge conductive portion formed along a first sidewall, a bottom conductive portion formed on a second planar surface and a second edge conductive portion formed on a second sidewall. The top conductive portion and the first edge conductive portion form a first L-shaped structure, the bottom conductive portion and the second edge conductive portion form a second L-shaped structure, and the first L-shaped structure and the second L-shaped structure are configured to form a low ac resistance structure. The coil also has an insulation material inside the conductive structure and a plurality of terminals formed with the plurality of conductors for connecting the coil.

According to another embodiment of this disclosure, a system has a first coil with a plurality of conductors, an insulation material inside the plurality of conductors, and a second coil coupled to the first coil. The first coil has a width much bigger than a thickness in a 3D structure, and the plurality of conductors forms a conductive structure having a top conductive portion formed on a first planar surface, a first edge conductive portion formed along a first sidewall, a bottom conductive portion formed on a second planar surface and a second edge conductive portion formed on a second sidewall. The top conductive portion and the first edge conductive portion form a first L-shaped structure, the bottom conductive portion and the second edge conductive portion form a second L-shaped structure, and the first L-shaped structure and the second L-shaped structure are configured to form a low ac resistance structure.

According to yet another embodiment of this disclosure, an apparatus has a first coil with a plurality of conductors in a 3D structure, an insulation material inside the plurality of conductors, and a plurality of terminals formed with the plurality of conductors for connecting the coil to other components in the apparatus. The first coil has a width much bigger than a thickness, and the plurality of conductors forms a conductive structure with a top conductive portion formed on a first planar surface, a first edge conductive portion formed along a first sidewall, a bottom conductive portion formed on a second planar surface and a second edge conductive portion formed on a second sidewall. The top conductive portion and the first edge conductive portion form a first L-shaped structure, the bottom conductive portion and the second edge conductive portion form a second L-shaped structure, and the first L-shaped structure and the second L-shaped structure are configured to form a low ac resistance structure.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates examples of planar conductors in accordance with various embodiments of the present disclosure;

FIG. 2 illustrates a multi-turn coil in a planar construction with a transition area in accordance with various embodiments of the present disclosure;

FIG. 3 illustrates another multi-turn coil in a planar construction with a transition area in accordance with various embodiments of the present disclosure;

FIG. 4 illustrates a multi-turn coil in a planar construction with a gradual transition in accordance with various embodiments of the present disclosure;

FIG. 5 illustrates a 3D view of a multi-turn coil in a planar construction with a gradual transition in accordance with various embodiments of the present disclosure;

FIG. 6 illustrates another multi-turn coil in a planar construction with a gradual transition and two terminals located together in accordance with various embodiments of the present disclosure;

FIG. 7 illustrates a multi-turn coil in a planar construction with a cascaded pattern in accordance with various embodiments of the present disclosure;

FIG. 8 illustrates a multi-turn coil in a planar construction with extruded terminals in accordance with various embodiments of the present disclosure;

FIG. 9 illustrates a swapping connection of terminals in accordance with various embodiments of the present disclosure;

FIG. 10 illustrates a multi-turn coil having 2 planar patterns connected in series through a swapping connection in accordance with various embodiments of the present disclosure;

FIG. 11 illustrates a multi-turn coil in a planar construction having a round shape with a gradual transition in accordance with various embodiments of the present disclosure;

FIG. 12 illustrates a multi-turn coil in a planar construction having a round shape with a gradual transition and two terminals located together in accordance with various embodiments of the present disclosure;

FIG. 13 illustrates multi-layer constructions for planar conductors in accordance with various embodiments of the present disclosure;

FIG. 14 illustrates a multi-layer construction for planar conductors with layers in series in accordance with various embodiments of the present disclosure; and

FIG. 15 illustrates a coil with connection to another component implemented on a printed circuit board in accordance with various embodiments of the present disclosure;

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely coils for a power processing devices and systems. The invention may also be applied, however, to a variety of other device or systems, including integrated circuits, power converters, power supplies, bus bars, cables, signal processing circuit or devices, any combinations thereof and/or the like. Hereinafter, various embodiments will be explained in detail with reference to the accompanying drawings.

Power efficiency, electromagnetic emission, system reliability and system cost have been critical factors impacting the design and adoption of power processing systems such as WPT technologies. This is especially true for high power applications such as fast charging, where a high charging power is required within a limited space and limited power loss budget. This disclosure presents innovative techniques that can provide significant improvement in these aspects, especially aiming at maintaining a good efficiency and low power loss over a wide range of power and voltage. Although the invention will be discussed in a context of power coil applications, it can be also applied to other signal transmission or power conversion applications, in which some of the coils may be combined into a transformer or simplified to cables or bus bars.

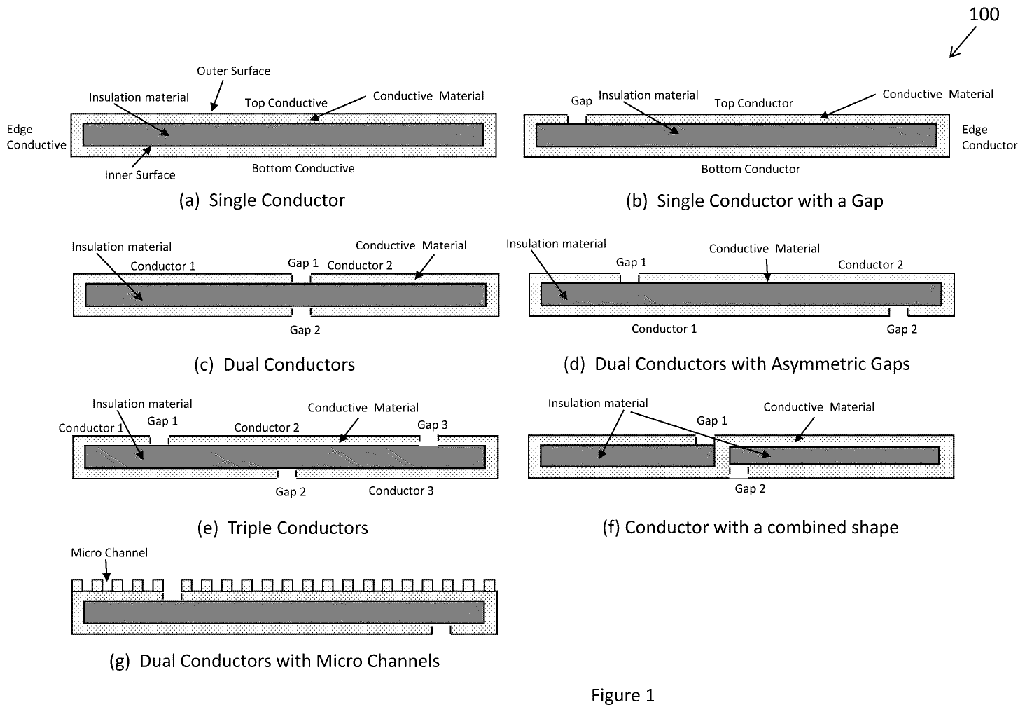

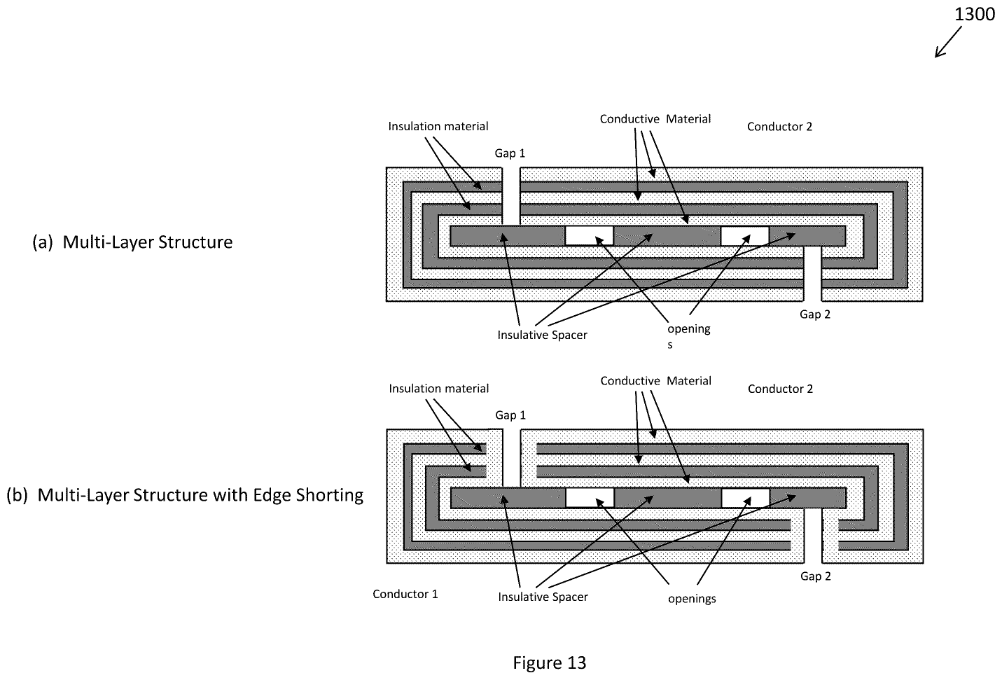

To reduce the impact of skin depth, it is desirable to use a sheet-like tabular structure which has a width much bigger than its thickness. Sometimes this kind of tabular structure is also called a planar structure, and in this disclosure planar is used interchangeably with tabular. FIG. 1 shows several examples, in which (and other drawings in this disclosure) electrically conductive materials are illustrated as dotted area, and insulation materials are illustrated as solid grey areas. FIG. 1(a) shows the cross section of a single conductor structure. The width of the conductor (i.e. the distance from the left edge (or alternatively called left sidewall) to the right edge (or alternatively called right sidewall)) is much bigger than (for example, at least 3 times bigger) than its thickness (i.e. the distance from the top surface to the bottom surface), and inside the conductive material is an insulation material. Throughout this disclosure, the conductive material on the top side of the insulation material is called a top portion conductive or equivalently a top conductor, the conductive material at the bottom side of the insulation material is called a bottom portion conductive or equivalently a bottom conductor, and the conductive material at an edge or sidewall of the insulation material is called an edge (side) portion conductive or equivalently an edge (side) conductor. At least one of the top conductor and the bottom conductor is coupled to each edge conductor (or side conductor), forming an L-shaped conductive structure which creates resistance against a magnetic field entering the side (and thus the space between the top and bottom conductors) of the conductor. With the two L-shaped conductive structures arranged to form an enclosed (or almost enclosed) conductive structure, the magnetic field inside the conductive structure is very low, i.e. the magnetic field strength along the inner surface of the conductive structure is much lower than the magnetic field strength along the outer surface of the conductive structure in most or all of circumference of the conductive structure. Therefore, the ac resistance of such a conductive structure is small, or much reduced by such arrangement of two or more L-shape conductive structures. Although one conductor is shown in FIG. 1(a), such a conductive structure can have more conductors as will be explained later. With a planar or tabular structure having much larger width than thickness in a multi L-shaped conductive arrangement, a conductive structure with multiple conductors has very low approximate effect among the conductors, and thus also low ac resistance at high frequency. The conductive material which forms the conductive part of the conductors can be copper, aluminum, silver or other electrically conductive material or alloy. The top conductor and the bottom conductor are approximately parallel to each other, while the side conductors are approximately vertical to the top and bottom conductors. The insulation material can be air, an insulation liquid such as water, oil or other non-electrically-conductive liquid, or non-conductive solid materials such as silicon, paper, plastic, or glass material such as FR4 or FR5 material used in printed circuit boards (PCBs). As an example, the insulation material may be a magnetic material such as ferrite or other magnetic compounds, which generally has very low electrical conduction and thus can function as an insulation material. An insulation/magnetic material may also be placed on one or sides of the conductor if needed. The material and the thickness of top conductor, bottom conductor and edge conductor, formed by the conductive material or materials, may be the same or may be different. The top conductor, the bottom conductor and the edge conductor may be connected together as is shown in the figure, or may be separated but an edge conductor should be connected to at least one of the top conductor and/or bottom conductor, so that magnetic field cannot penetrate into the side of the conductor structure easily. The conductor surfaces may be flat as is shown, or be uneven or have other features such as micro channels. The conductive materials may be formed with different processes, such as bending, plating, bonding, sputtering, depositing, printing, gluing, soldering, welding or any combination thereof. For example, the edge conductor may be formed by an edge-plating process in a PCB manufacture process. In a different embodiment, the conductor may be formed by a conductive foil, tape or other thin conductive sheets folded around an insulation sheet such as a paper or dielectric tape. As explained earlier, because the conductive material forms a 3D enclosed shape with the edge conductors, the inside surfaces of the structure sees no or low magnetic field, the ac resistance of the conductor is relatively low compared to sheet connectors with the same size without the edge conductors. FIG. 1(b) is similar to FIG. 1(a) except that a gap is introduced in one of the conductors. The gap may be formed by as unprocessed space in a plating, printing, plating, depositing or bending process, or be internally cut out through a wire cutting, laser cutting or etching process. The gap may be used to introduce a new feature, such as connecting external cooling liquid or used as a cooling interface. The location of a gap may be on the top side, on the bottom side, or along the edge of the conductor. With one gap, the inside surfaces of the conductive material generally sees low magnetic field, and thus the conductor has still relatively low ac resistance. FIG. 1(c) is similar to FIG. 1(b) except that one more gap is introduced and the two gaps divide the conductive surface into 2 conductors. The two conductors may carry currents in opposite directions such as in a bus bar (in that case, this structure itself can be used as a bus bar to connect positive and negative power rails, or conduct a high frequency signal. The two conductors in the dual structure may carry currents in the same direction to be used as paralleled conductors, which may be used to build closely coupled coils or inductors, or form a multi-turn coil. The position of the gaps can be configured such that the inner surfaces of the conductive material see low magnetic field strength, so the ac resistance of the conductor is reduced. FIG. 1(d) is similar to FIG. 1(c) except that the gaps are in different locations. The locations of the gap may be used to optimize certain performance, such as a resistance, of the coils. Of course, this kind of structure can be used to implement more than 2 conductors. FIG. 1(e) shows an example of three conductors are combined in a triple conductor structure. In these structures, the positions of airgaps may be fixed, or may vary along the length of the conductor. The dimension of the conducive material, especially the thickness and width, and that of the insulation material including its thickness and width, may be coordinated to achieve desired performance. Please note that the insulation material may be a combination of different materials, for example, as a plurality of plastic spacers separated by air gaps or openings, as will be illustrated later in FIGS. 13-15. Such air gaps in the insulation materials (also alternatively called openings in this disclosure) can reduce the weight and cost of the insulation material, and also allow additional feature such as cooling liquid be filled into them. The insulation material can be configured to have proper electrical or magnetic properties such as dielectric constant to give a good performance of the system. For example, the insulation material may have a proper dielectric performance to for a distributed capacitor or a plurality of lumped capacitors along the conductor, which is part of a filter together with the conductor. Such capacitors may form a resonator together with the conductor/coil. Different cross-section shapes may be used to give desired performance. For example, instead of a rectangular shape, an oval shape may be used. Different shapes may be combined also. FIG. 1(f) shows a combination of two rectangular shapes, which can be easily formed by bending, folding or plating. FIG. 1(g) shows one side of the conductors has micro channels, which form many small conductive pillars separated by small channels, and the dimensions of a pillar and/or a channel is in the range of skin-depth for the working frequency (for example, in the range of 0.5-5 times the skin depth). The micro-channel structure further increases the surface area of the conductor and thus reduce the resistance of the conductor at high frequencies. Although in FIG. 1(g) only the top side of the conductor is shown to have a micro-channel structure, similar micro-channel structures can also be applied to the bottom side, or edges of the conductor if needed.

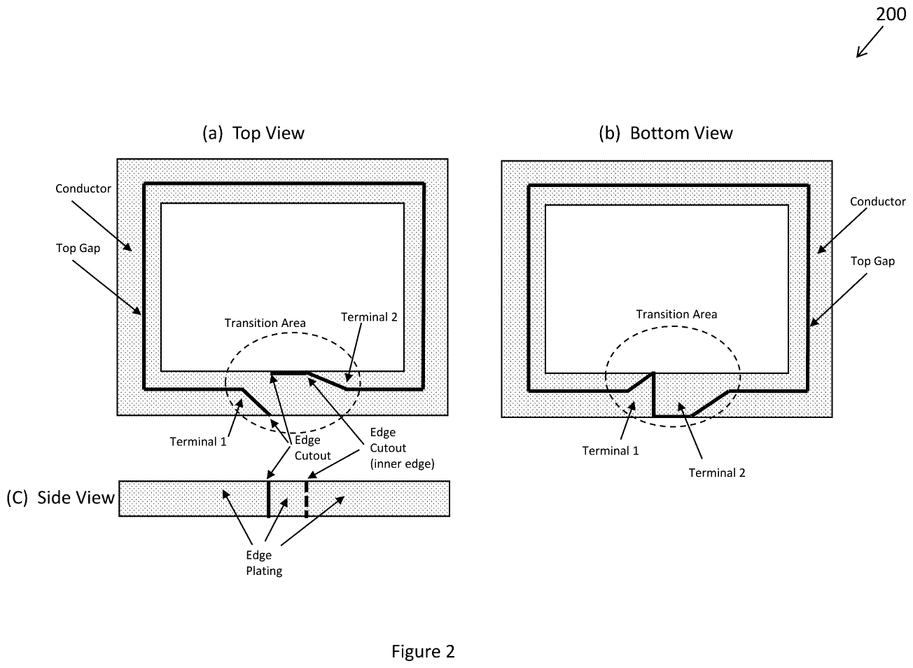

The structures in FIG. 1 generally use 3D conductors with a more or less enclosed 3D shape to reduce the magnetic field strength a long at least one side of the surfaces of the conductors. The shown structures can be used as basic elements for more complex component. For example, they can be used to design and build coils with low resistance for use in various devices, such as power supplies or wireless power transfer systems. The structures shown in FIG. 1 are just cross sections, and a coil can be designed with various patterns longitude-wise (along its length) using such cross-sections. FIG. 2 shows an example to use a double (or equivalently dual) conductor structure to build a 2-turn coil with a roughly rectangular shape (of course, other shapes are also feasible). The dotted areas illustrate the conductive material, and the thickened black lines illustrate gaps, which are used to separated different turns of the coil, and such gaps need to be wide enough to withstand required voltage during operation. Inside the conductive materials there is an insulation material as is shown in FIG. 1, but not shown in FIG. 2 (and thereafter when appropriate) for the sake of brevity. In FIG. 2, in most areas the gaps on the top surface and bottom surface are in fixed locations relative to the edge of the coil and thus are shown as straight lines, except in a transition area. In the transition area, the outer turn is connected to the inner turn by moving the two gaps along the longitude of the conductors. That is, in the transition area the gaps' location changes relative to the edge of the edges along the length, which may form a straight line or a spiral line, or other curves to transform the end of the first conductor (turn) to the beginning of the second turn, providing a natural and smooth connection of two turns of the coil. In FIG. 2, the transition (i.e. the position changing of the gaps to provide a natural and smooth connection of different turns) is realized in a segment of the coil illustrated as the transition area. On the sides, the gap may follow a straight line which can be easier to manufacture in some process such as edge plating or wire cutting. Please note that the surface area for the inner turn may be smaller than the outer turn by positioning the gaps properly. For example, if using a cross-section structure similar to FIG. 1(c) and FIG. 1(d), Conductor 1 can be deliberately designed to have a bigger area than Conductor 2. A conductor should have at least some conductive material on an edge and at least one (and preferably both) of the top side and the bottom side of the coil to form a 3D structure with low magnetic field strength along its inner surface. Again, this will result in 2 L-shaped conductive structures on cross sections along the length of the coil. Although a rectangular shape is shown for the coil in FIG. 2, any shape can be used, such as round or oval shapes, or any combination of regular or irregular shapes, such as a rectangular shape with rounded corners, may be used to meet system requirements. The coil may be manufactured with various processes, such as bending, cutting, plating, printing depositing, sputtering, etching or any combination of. For example, the coil may be manufactured on a silicon carrier, plastic carrier, as a PCB or on a PCB, or on a PCB with other circuits. Again, the insulation material can be configured to have proper electrical or magnetic properties such as dielectric constant to give a good performance of the system. For example, the insulation material may have a proper dielectric property and form a distributed capacitor or a plurality of lumped capacitors along the length of the coil, which may be used as part of a resonator together with the coil if needed. To connect the coil to outside circuit, two terminals are formed.

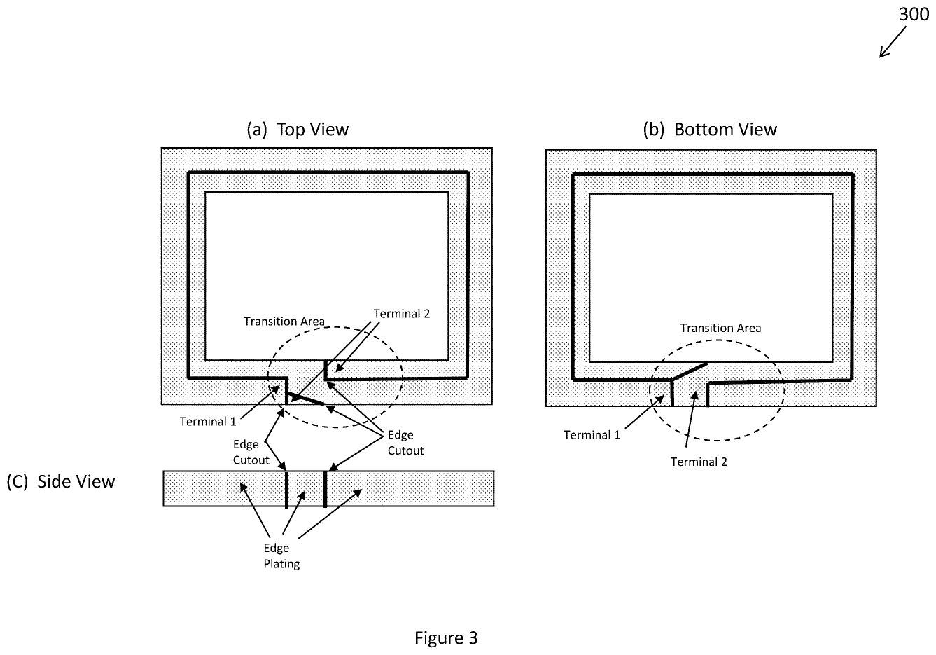

In FIG. 2, the two terminals, which are used to connect the coil to other components, are on opposite sides of the conductors. In some applications, it may be desirable to have the two terminals on the same side, for example on the outside of the coil for easier interconnection. Such a structure is shown in FIG. 3, which is similar to FIG. 2 except that that transition area is configured differently to have a faster transition, so both terminals can be aligned on one side of the coil in adjacent areas to facilitate interconnection with other components of the system. Within the transition area in FIGS. 2 and 3, the positions of the gaps changes in a linear fashion long the length direction (longitude) of the conductors. The change of gap positions may follow other patterns such as a spiral curve if desired. Please not the positions of the two gaps on the top side and bottom side can be coordinated so that the width of the conductive materials for both conductor 1 (the outer turn) and conductor 2 (the inner turn) is almost constant in the transition area. For the example, for the conductor cross section shown in FIGS. 1(c) and (d), if the gap on the top moves in one direction, then the gap on the bottom side may move in the opposite direction. In this way, the resistance of the coil may be reduced.

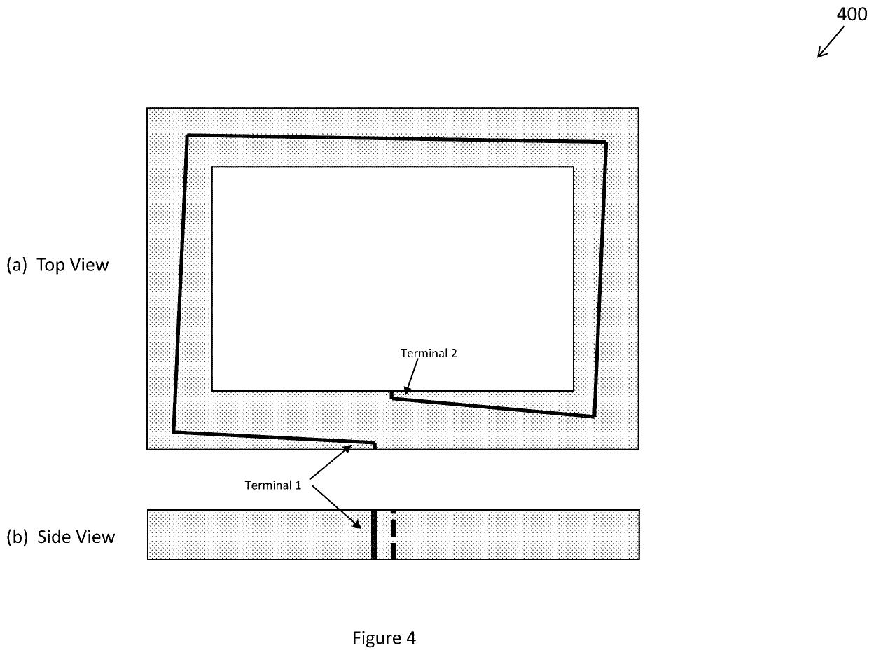

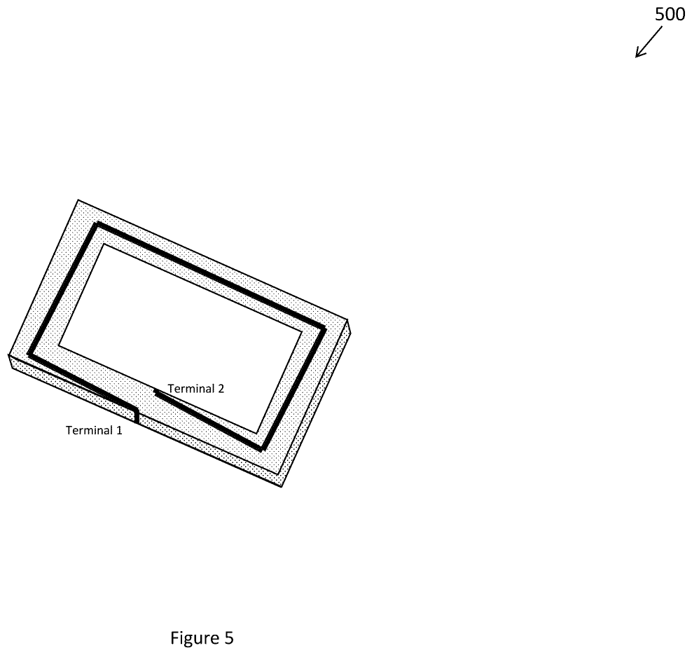

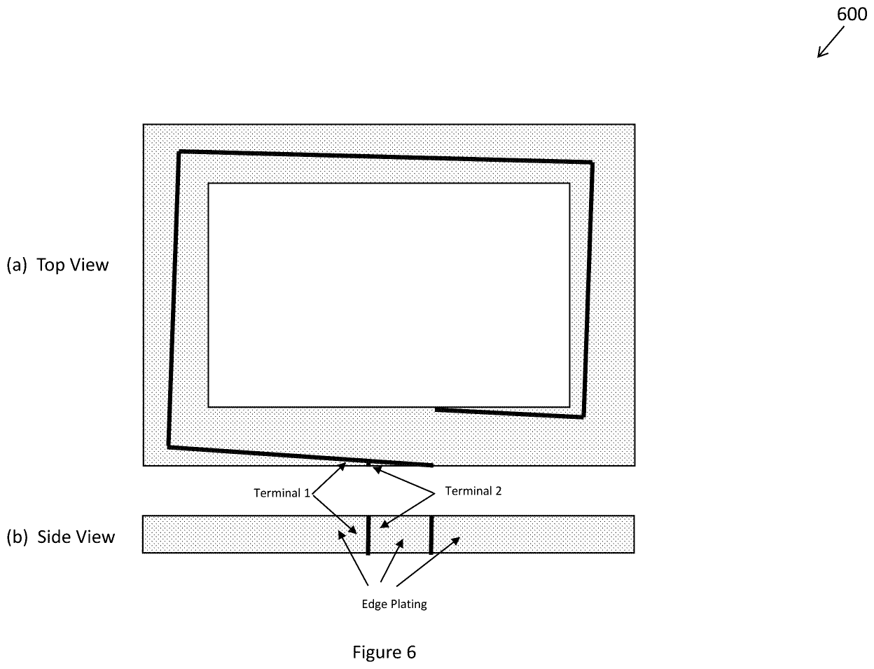

Sometimes, it may be desirable to form the transition from one turn to another turn gradually and smoothly along the length of the turns, which may be realized by moving the positions of the gaps gradually along the length of the coil. FIG. 4 shown an example of smooth and gradual transition based on the pattern FIG. 2. As noted previously, the corners of the gap and/or the conductive surfaces may be rounded up. FIG. 5 shown a 3D view of the drawing in FIG. 4. FIG. 6 shows an example of gradual transition version of the pattern shown in FIG. 3, in which the two terminals are located side by side on one side of the coil.

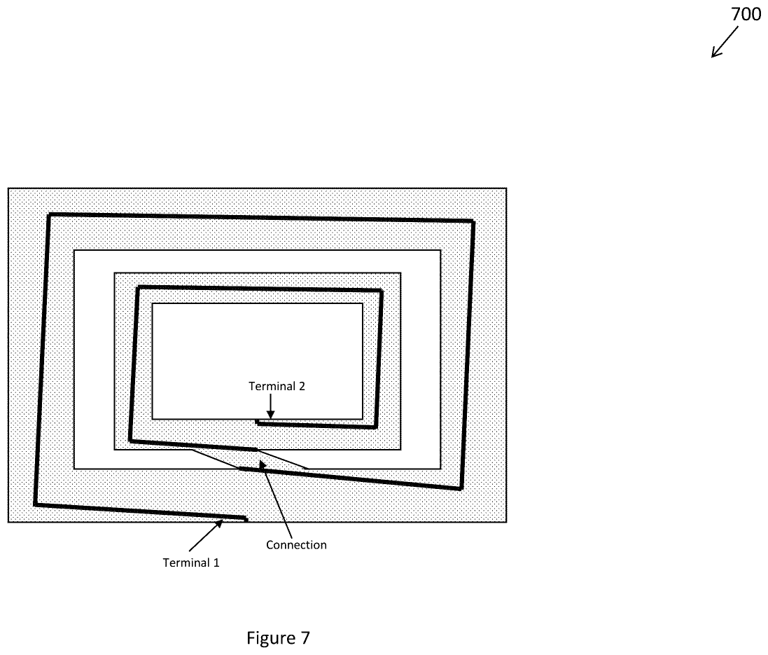

A two-turn coil is shown in FIGS. 2 through 6. A similar 1-turn or three-turn structure with similar features may be built similarly with the cross section shown in FIG. 1(a), 1(f) or 1(e). Of course, more than one coils with more than 2 turns can also be implemented by cascading two-turn and/or single-turn structures. FIG. 7 shows a 4-turn structure with 2 cascaded 2-turn structures, where a 2-turn substructure is cascaded into another 2-turn substructure. The connection of two substructures can also use a planar structure like the one shown in FIG. 1(a).

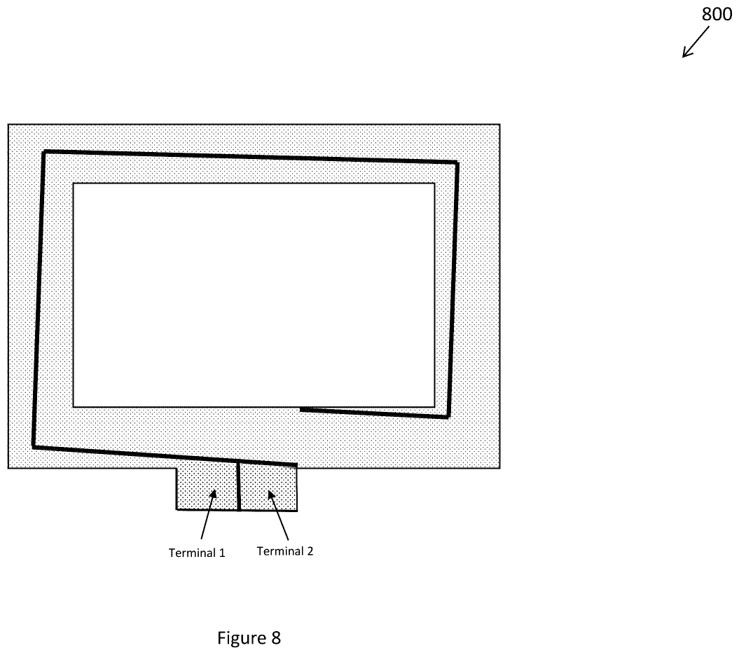

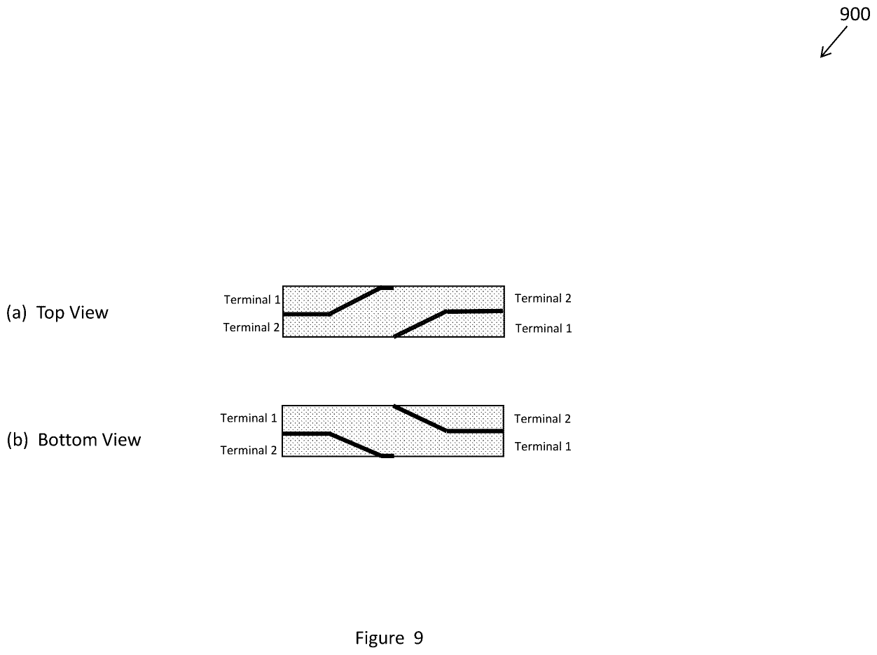

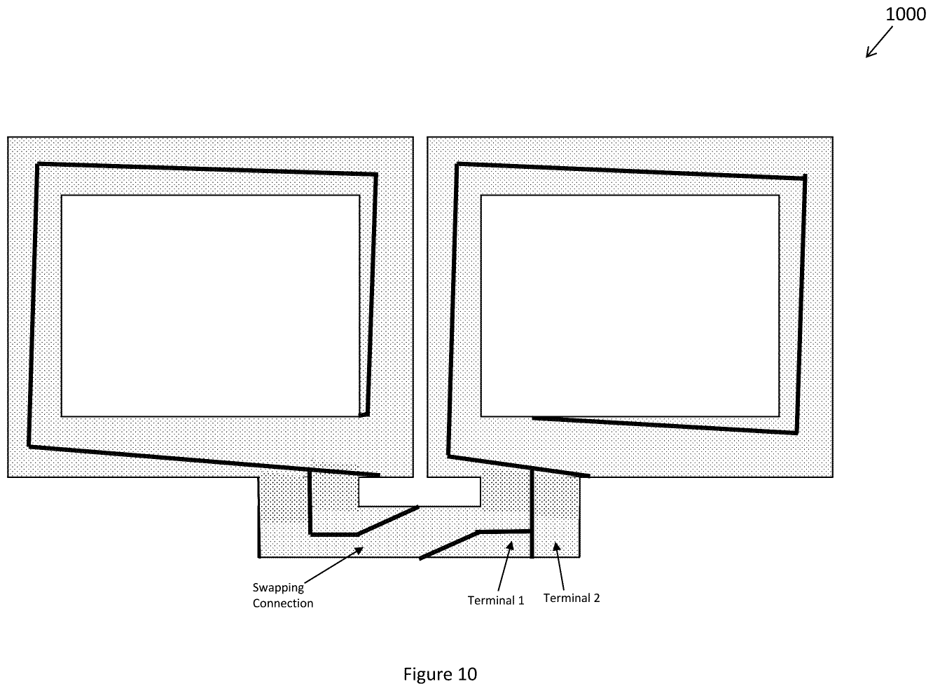

The above discussed planar structures can be used as building blocks to construct more complex structures. To facilitate connection to other parts in a circuit, the terminals may be built into various shapes. FIG. 8 shows two terminals arranged side by side using the structure in FIG. 6. The two terminals may be arranged in a pattern similar to FIG. 1(c) or 1(d). Sometimes it may be desired to interchange the positions of the terminals to make easier connections to another part. FIG. 9 shows such a swapping connection which may be implemented as a planar structure similar to the patterns shown in FIGS. 1(c) and 1(d) with linear transition, in which the relative position of the terminals is reversed from one side (e.g. the left side) to another side (e.g. the right side). FIG. 10 shows an example to use such a swapping connection to combine two two-turn structures similar to the pattern in FIG. 8 into a bipolar coil, where the two two-turn structures produce flux with opposite direction, to reduce emission into outside environment.

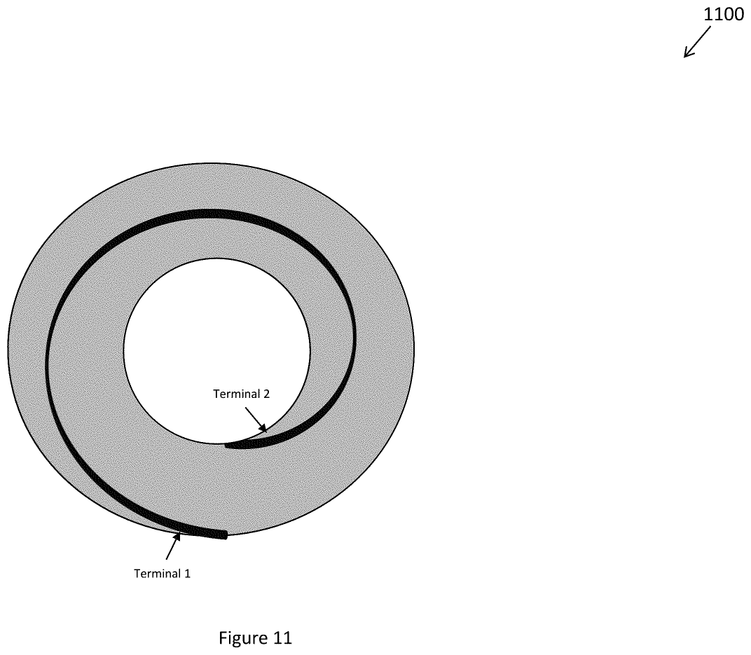

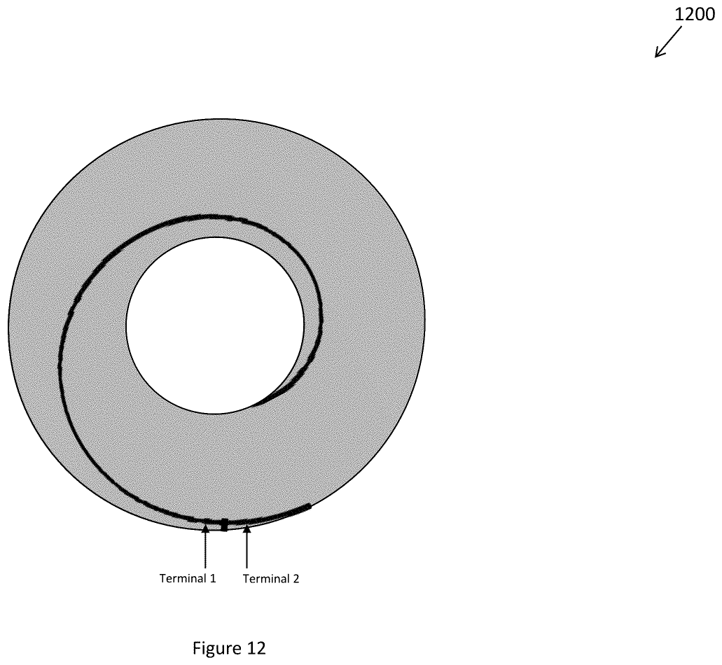

In the above discussion, rectangular shapes with linear transition (the gap are formed by multiple straight lines) are shown. As noted above, different shapes, and different forms of transition or gap may be used to meet different design requirements. FIG. 11 shows a round shape with a spiral transition or spiral gap as an example which is a counterpart to FIG. 4 with a linear transition. The connection terminals in FIG. 11 are located at different sides of the coil, Terminal 1 at the outer side, and Terminal two at the inner side. FIG. 12 shows a round shape coil with a spiral transition or spiral gap as an example which can be considered as a counterpart to FIG. 6. In FIGS. 11 and 12, the transition between one turn and another turn is distributed practically along the whole length of the coil, so the gap moves smoothly along the length. Of course the gap may be other shapes if desired, for example a circle with a constant radius most part together with a short arc or spiral, one or more line in one or more segments, or other types of transition area can be used if needed.

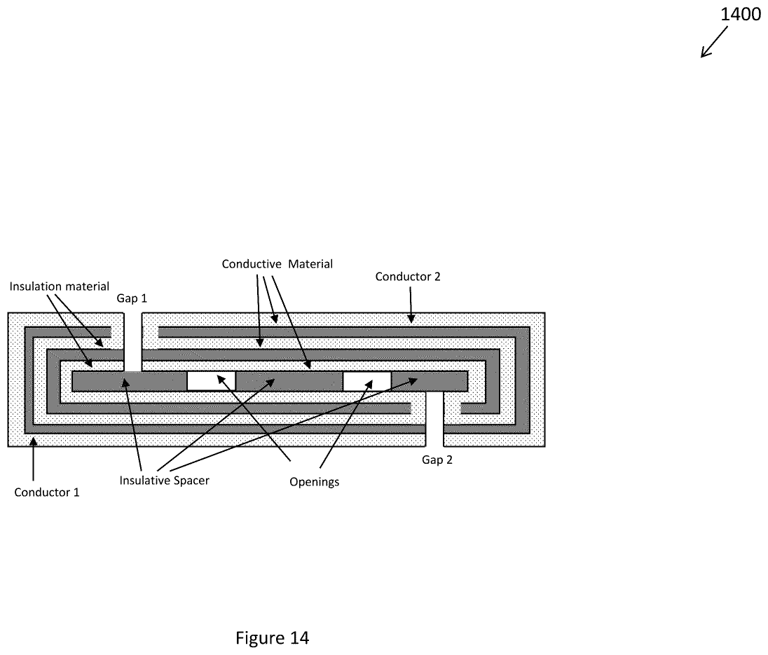

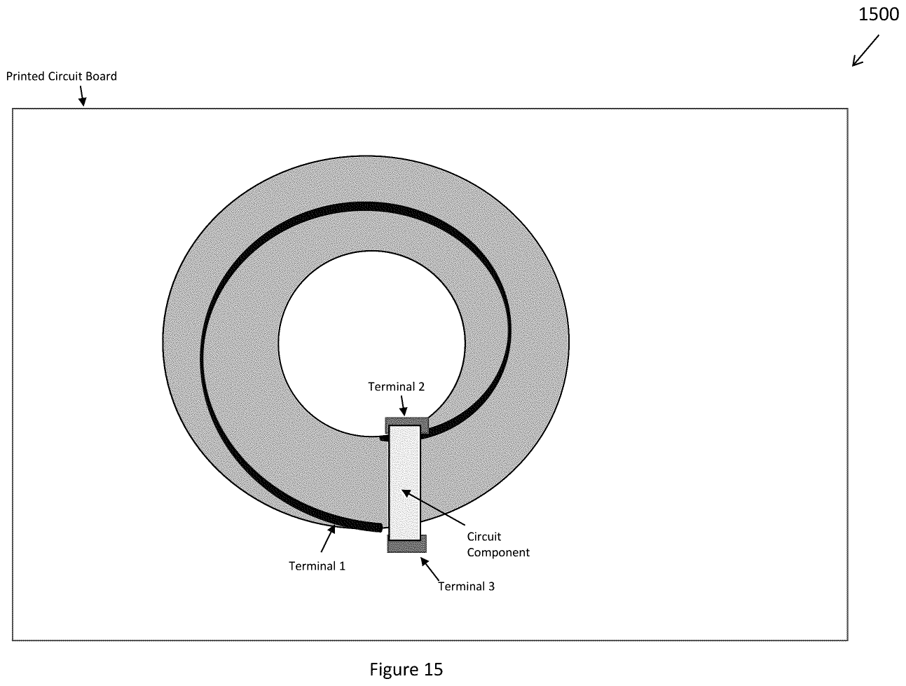

To further reduce the ac resistance, especially at very high frequency, multi-layer planar structures can be used. FIGS. 13(a) and 13(b) shows a three-layer structure as an example, where the conductive material is divided into 3 layers separated with multiple layers of insulation materials. The thickness of each conductive layer or insulation layer may be different or the same. Please note that the insulation material at the center (core) of the structure may be divided into several bars with air gaps with them. The center insulation may use the same material as other layers or use different materials. The insulation materials of different layers may be different, and the conductive materials of different layers may also be different metals or alloys. As is shown in FIG. 13 (and later in FIGS. 14 and 15), a layer of insulation material may have a plurality of voids, which may be an air gap or other opening. As is discussed previously regarding FIG. 1, such air gaps or openings may be used advantageously.

Sometimes it may be desirable to short the conductive layers along the length of the conductor, in the whole length or at selected areas. FIG. 13(b) shows a cross-section view with shorting features combined with gaps. Such shorting features can be formed through a proper process such as soldering, printing, plating, or depositing as a separate process step or combined with other fabrication steps of the coil, such as in a PCB fabrication process. Additional shorting may also be used, for example implemented as plated vias in a PCB design and fabrication. The shorting features in FIG. 13(b) connect the conductive layers in parallel. It is also possible to put the conductive layers in series by a different arrangement of the shorting feature, as is shown in FIG. 14.

Please note that the gaps (or air gaps) discussed in this disclosure are used to separate conductive materials of different turns electrically. They may be filled with an insulation material if desired. Such insulation materials may have weak electric conductivity, such as various magnetic materials.

In a wireless power transfer system, an important aspect in coil design is to reduce coil resistance while improving the magnetic coupling between or mutual inductance of the transmitter coil and receiver coil, as the mutual inductance between the transmitter coil and the receiver coil is directly related to the power transfer between them. In such case, the planar structures discussed in this disclosure can be used to implement the transmitter coil or the receiver coil, with the width of the conductor optimized to achieve the highest ratio of mutual inductance over coil resistance (either of the transmitter coil or the receiver coil, or the sum of both). This is much better than just optimizing the ratio of inductance over resistance of a coil, since it results in better system performance, for example better power efficiency. This principle can also be used for transformers, as a transformer is actually a multi-coil system with good magnetic coupling between the coils.

Coils or conductors may be manufactured from a carrier such as a PCB. The edge of the coils or conductors may be formed through a stamping, punching, routing, cutting or etch process. The side conductive surfaces may be formed by a plating or other addictive process, such as edge plating in PCB fabrication.

A coil may be integrated with another part, for example formed on a case of a device, such as in a plastic housing of a hearing aid, watch, glass, laptop computer, cell phone or TWS pod. A coil may be formed on a PCB or another kind of carrier which also supports other components of a system. Especially, a resonant capacitor or other components electrically coupled to the coil may be put on or buried (embedded) inside such carrier. FIG. 15 shown a coil implemented on a PCB with a component connected to one of the terminals of the coil. The component may be placed outside the coil or inside the coil, and be put on a surface of the PCB or buried inside the PCB, or embedded into a PCB in a partially buried version.

Although conductive material is shown at the outside surface of the structures, it may be covered totally or partially with a magnetic material or insulation material if needed.

The innovation ideas in this disclosure may reduce the power loss of a coil, a winding, a bus bar, or other conductors, and improve system performance significantly if conductive loss is a significant portion of total power loss.

This disclosure has given examples to illustrate the invention. There may be different variants in implementation. For example, multiple coils can be combined into a transformer. Also, although this invention disclosure is presented in the context of wireless power transfer, the technology disclosed may be used for other applications such as in power converters, power supplies, and wired charging equipment.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A coil comprising:
a plurality of conductors having a width much bigger than a thickness in a 3D structure, wherein the plurality of conductors forms a conductive structure having a top conductive portion formed on a first planar surface, a first edge conductive portion formed along a first sidewall, a bottom conductive portion formed on a second planar surface and a second edge conductive portion formed on a second sidewall, and wherein the top conductive portion and the first edge conductive portion form a first L-shaped structure, and the bottom conductive portion and the second edge conductive portion form a second L-shaped structure, and wherein the first L-shaped structure and the second L-shaped structure are configured to form a low ac resistance structure;
an insulation material inside the conductive structure; and
a plurality of terminals formed with the plurality of conductors for connecting the coil.

2. The coil of claim 1, wherein:
the insulation material is a magnetic material.

3. The coil of claim 1, wherein:
the insulation material is solid and has a plurality of openings, and a cooling liquid is filled into at least one of the openings

4. The coil of claim 1, wherein:
a first gap is on the first planar surface, and a second gap is on the second planar surface, and wherein the first gap and the second gap separate the plurality of conductors into different turns.

5. The coil of claim 4, wherein:
two turns of the coil are connected by a transition segment with a linear or spiral transition along the length of a conductor in the plurality of conductors.

6. The coil of claim 5, wherein:
the linear or spiral transition is distributed along approximately the whole length of the coil.

7. The coil of claim 1, wherein:
the plurality of conductors has multiple layers of conductive materials separated by a plurality layers of insulation materials.

8. The coil of claim 7, wherein:
the multiple layers of conductive materials are connected in parallel.

9. The coil of claim 7, wherein:
the c multiple layers of conductive materials are connected in series.

10. The coil of claim 1, wherein:
the insulation material is configured to form a plurality of capacitors with the conductive material.

11. A system comprising:
A first coil comprising:
a plurality of conductors having a width much bigger than a thickness in a 3D structure, wherein the plurality of conductors forms a conductive structure having a top conductive portion formed on a first planar surface, a first edge conductive portion formed along a first sidewall, a bottom conductive portion formed on a second planar surface and a second edge conductive portion formed on a second sidewall, and wherein the top conductive portion and the first edge conductive portion form a first L-shaped structure, and the bottom conductive portion and the second edge conductive portion form a second L-shaped structure, and wherein the first L-shaped structure and the second L-shaped structure are configured to form a low ac resistance structure; and
an insulation material inside the plurality of conductors; and
a second coil coupled to the first coil.

12. The system of claim 11, wherein:
a first gap is on the first planar surface, and a second gap is on the second planar surface, and wherein the first gap and the second gap separate the plurality of conductors into different turns.

13. The system of claim 11, wherein:
the second coil has a similar structure to the first coil and is connected to the first coil through a swapping connection, and wherein the relative position of terminals are reversed from one side of the swapping connection to another side of the swapping connection, and wherein the second coil is placed close to one side of the first coil.

14. The system of claim 11, wherein:
the second coil has a structure similar to a structure of the first coil and is cascaded inside the first coil.

15. The system of claim 11, wherein:
the first coil and the second coil are magnetically coupled, and a width of one of the first coil and the second coil is so determined such that a ratio of a mutual inductance between the first coil and the second coil over a resistance of the first coil or the second coil is increased.

16. An apparatus having a first coil comprising:
a plurality of conductors having a width much bigger than a thickness in a 3D structure, wherein the plurality of conductors forms a conductive structure having a top conductive portion formed on a first planar surface, a first edge conductive portion formed along a first sidewall, a bottom conductive portion formed on a second planar surface and a second edge conductive portion formed on a second sidewall, and wherein the top conductive portion and the first edge conductive portion form a first L-shaped structure, and the bottom conductive portion and the second edge conductive portion form a second L-shaped structure, and wherein the first L-shaped structure and the second L-shaped structure are configured to form a low ac resistance structure;
an insulation material inside the plurality of conductors; and
a plurality of terminals formed with the conductors for connecting the coil to other components in the apparatus.

17. The apparatus of claim 16, further comprising:
a first gap is on the first planar surface, and a second gap is on the second planar surface, and wherein the first gap and the second gap separate the plurality of conductors into different turns.

18. The apparatus of claim 16, further comprising:
a second coil having a structure similar to the first coil, wherein the second coil is cascaded inside the first coil or placed close to one side of the first coil.

19. The apparatus of claim 16, wherein:
a magnetic material is put on a surface of the plurality of conductors.

20. The apparatus of claim 16, wherein:
the top conductive portion, the edge conductive portion and the bottom conductive portion have different thickness.
